(19) United States
(12) Patent Application Publication
(10) Pub. No.: US 2025/0375060 A1
(43) Pub. Date: Dec. 11, 2025

(54) MILK FROTHING ASSEMBLY

(71) Applicant: Tsann Kuen (Zhangzhou) Enterprise Co., Ltd., Zhangzhou (CN)

(72) Inventors: Mengxin HAN, Zhangzhou (CN); Yuandong LI, Zhangzhou (CN)

(21) Appl. No.: 19/235,533

(22) Filed: Jun. 11, 2025

(30) Foreign Application Priority Data
Jun. 11, 2024 (CN) 202421314713.0

(51) Int. Cl. A47J 31/44

(52) U.S. Cl. CPC A47J 31/4485; A47J 31/4407

(57) ABSTRACT

A milk frothing assembly includes a container, a lid, and a case body. The container is configured to contain liquid, and the lid covers the container. The milk frothing assembly includes a milk inlet pipe, a steam port, and a milk outlet pipe, and the milk inlet pipe is inserted into the container. An upper side of the lid forms a mixing groove, and the mixing groove is respectively connected to the milk inlet pipe, the milk outlet pipe, and the steam port. The case body is detachably connected to the upper side of the lid, and a lower side of the case body is configured to seal the mixing groove to form a mixing chamber. An air inlet port is connected to the mixing chamber, and the steam port is configured to receive steam.

### RELATED APPLICATIONS

This application claims priority to Chinese patent application number 202421314713.0, filed on Jun. 11, 2024. Chinese patent application number 202421314713.0 is incorporated herein by reference.

### FIELD OF THE DISCLOSURE

The present disclosure relates to a milk frothing assembly.

### BACKGROUND OF THE DISCLOSURE

In existing coffee machine milk containers, the milk frothing assembly is often non-removable or has few detachable parts, making it difficult to effectively clean the milk frothing assembly. Alternatively, the structure may be overly complex, and not easy to disassemble and clean. Particularly for the chamber where steam and milk are mixed and frothed, this chamber is typically enclosed and cannot be conveniently disassembled for cleaning.

### BRIEF SUMMARY OF THE DISCLOSURE

The technical problem to be solved by the present disclosure is to provide a milk frothing assembly, which is easy to clean.

In order to solve the above technical problems, the present disclosure provides the milk frothing assembly, and the milk frothing assembly comprises a container, a lid, and a case body.

The container is configured to contain liquid, and the lid covers the container. The milk frothing assembly comprises a milk inlet pipe, a steam port, and a milk outlet pipe, and the milk inlet pipe is inserted into the container. An upper side of the lid forms a mixing groove, and the mixing groove is respectively connected to the milk inlet pipe, the milk outlet pipe, and the steam port. The case body is detachably connected to the upper side of the lid, and a lower side of the case body is configured to seal the mixing groove to form a mixing chamber. An air inlet port is connected to the mixing chamber, and the steam port is configured to receive steam.

In a preferred embodiment, the upper side of the lid comprises one or more first hooks and one or more second hooks. A first side of the case body is buckled to the one or more first hooks, and a second side of the case body is buckled to the one or more second hooks.

In a preferred embodiment, the one or more second hooks are elastic hooks. When the first side of the case body is buckled to the one or more first hooks, the second side of the case body is configured to be rotated around the one or more first hooks as a center of rotation to be buckled to the one or more second hooks.

In a preferred embodiment, the first side of the case body comprises two buckles spaced apart from each other, and the one or more first hooks on the upper side of the lid are two first hooks spaced apart from each other. Each of the two first hooks comprises an upright wall and a bent arm connected to an upper end of the upright wall, and the two buckles are configured to be rotatably buckled on the bent arms of the two first hooks. The second side of the case body comprises a protruding portion, and the one or more second hooks on the upper side of the lid are a single elastic hook, which is buckled to the protruding portion. The single elastic hook is configured to be released from a buckling connection with the protruding portion by an external force.

In a preferred embodiment, the steam port is connected to the case body, and the lower side of the case body forms a steam outlet port connecting the steam port and the mixing chamber.

In a preferred embodiment, the mixing groove comprises a steam section, a mixing section, and a steam outlet section, and the mixing section is connected to the steam section and the steam outlet section. A width of the mixing section is smaller than a width of the steam section and a width of the steam outlet section, and the milk inlet pipe is connected to the mixing section. The milk outlet pipe is connected to the steam outlet section, and when the lower side of the case body seals the mixing groove, the steam outlet port is connected to the steam section, and the air inlet port corresponds to the mixing section.

In a preferred embodiment, the steam outlet section is circular, and the steam outlet section comprises an outlet. The outlet is connected to the milk outlet pipe, and the outlet and the mixing section are respectively tangentially connected to the steam outlet section.

In a preferred embodiment, the lid is detachably connected to the container. The milk outlet pipe is rotatably connected to the lid, and the milk inlet pipe and the milk outlet pipe are detachably connected to the lid.

In a preferred embodiment, the upper side of the lid protrudes upwardly to form a rib structure, and the rib structure surrounds a space to form the mixing groove. The lower side of the case body comprises a sealing cushion structure, and the sealing cushion structure presses the rib structure to form the mixing chamber.

In a preferred embodiment, the milk frothing assembly comprises an air inlet valve, and the case body comprises an air inlet port. The air inlet valve forms the air inlet port, and the air inlet valve is detachably disposed on the case body.

Compared with the existing techniques, the technical solution has the following advantages.

The container is configured to contain the liquid, and the lid covers the container. The milk frothing assembly comprises the milk inlet pipe, the steam port, and the milk outlet pipe, and the milk inlet pipe is inserted into the container. The upper side of the lid forms the mixing groove, and the mixing groove is respectively connected to the milk inlet pipe, the milk outlet pipe, and the steam port. The case body is detachably connected to the upper side of the lid, and the lower side of the case body is configured to seal the mixing groove to form the mixing chamber. The air inlet port is connected to the mixing chamber, and the steam port is configured to receive the steam. The milk frothing assembly of the present disclosure has a simple structure and is easy to disassemble and assemble. When disassembly and cleaning are required, only the case body needs to be removed, allowing the entire mixing chamber to be conveniently cleaned.

### BRIEF DESCRIPTION OF THE DRAWINGS

FIG. 1 is a perspective view of a milk frothing assembly in a preferred embodiment of the present disclosure.

FIG. 2 is a perspective view of the milk frothing assembly with an upper lid removed in the preferred embodiment of the present disclosure.

FIG. 3 is a perspective view of the milk frothing assembly with the upper lid and a container removed in the preferred embodiment of the present disclosure.

FIG. 4 is a perspective view of a case body separated from the lid in the preferred embodiment of the present disclosure.

FIG. 5 is a cross-sectional view of the milk frothing assembly in the preferred embodiment of the present disclosure.

### DETAILED DESCRIPTION OF THE EMBODIMENTS

The present disclosure is further described below in conjunction with the accompanying drawings and specific implementation methods.

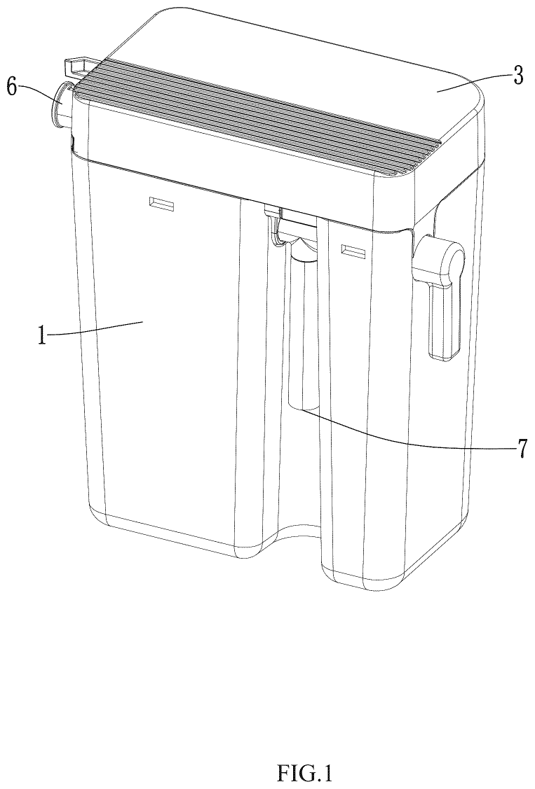

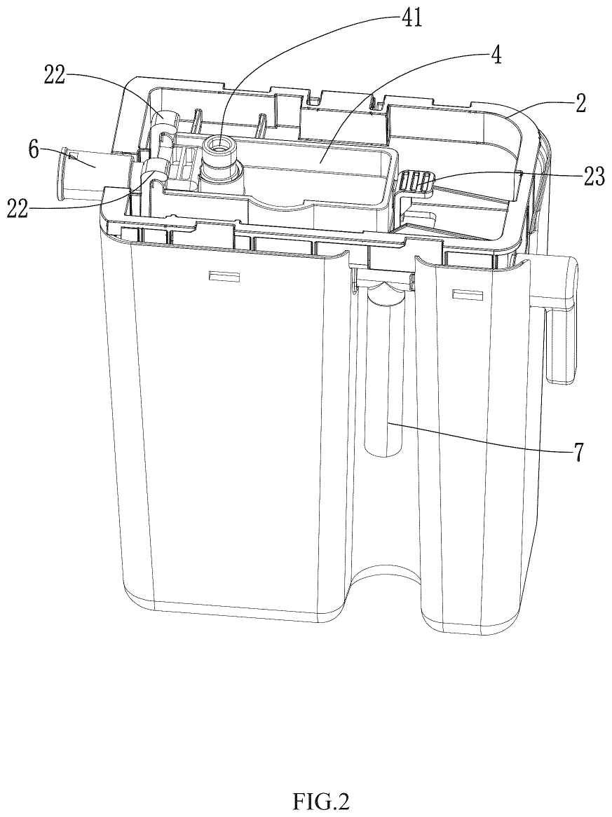

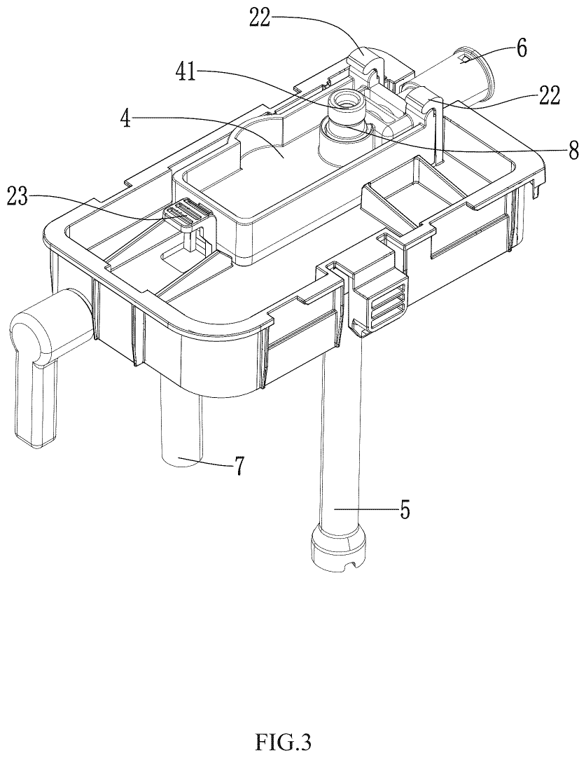

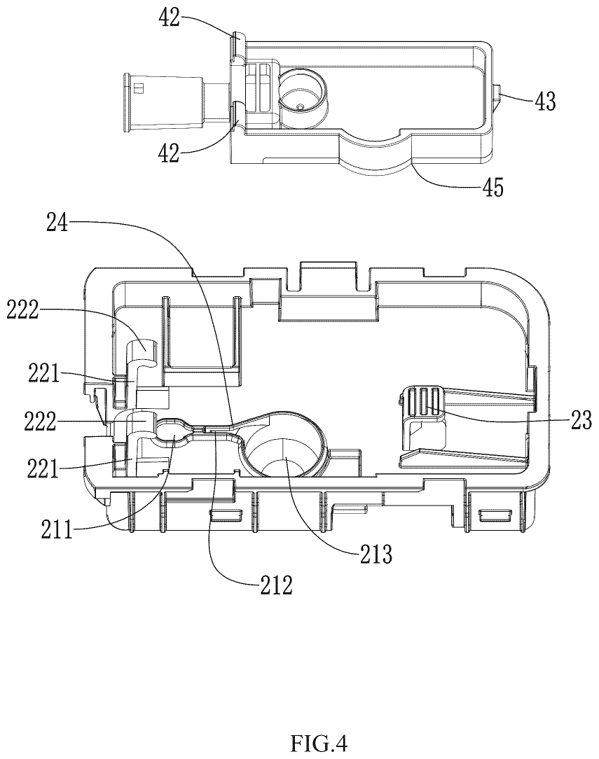

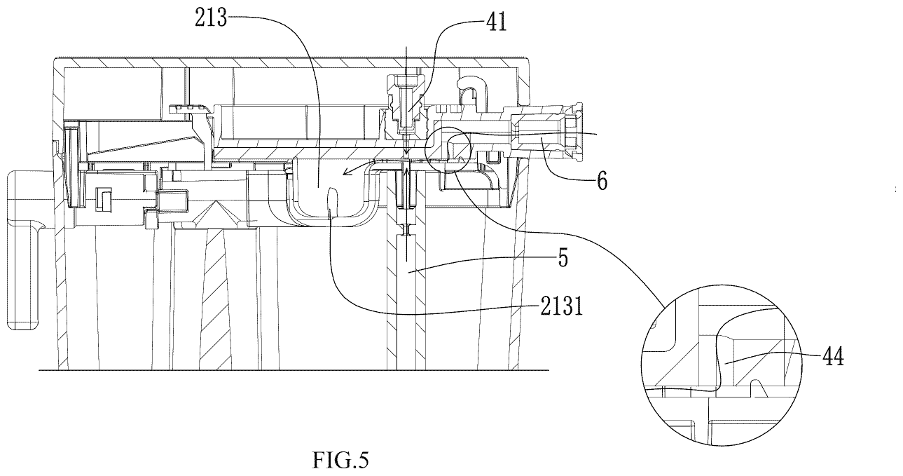

Referring to FIGS. 1 to 5, a milk frothing assembly is shown, and the milk frothing assembly comprises a container 1, a lid 2, and a case body 4.

The container 1 is configured to contain liquid, such as milk, and the lid 2 covers the container 1. The milk frothing assembly comprises a milk inlet pipe 5, a steam port 6, and a milk outlet pipe 7. The milk inlet pipe 5 is inserted into the container 1. An upper side of the lid 2 forms a mixing groove, and the mixing groove is respectively connected to the milk inlet pipe 5, the milk outlet pipe 7, and the steam port 6. The case body 4 is detachably connected to the upper side of the lid 2, and a lower side of the case body 4 is configured to seal the mixing groove to form a mixing chamber. The milk frothing assembly further comprises an air inlet port 41. The air inlet port 41 is connected to the mixing groove, and the steam port 6 is configured to receive steam. The milk frothing assembly further comprises an upper lid 3 covering an outside of the lid 2. The steam enters the mixing chamber, and the milk and air are sucked from the milk inlet pipe 5 and the air inlet port 41 through the flowing steam, wherein the milk and the air are mixed to form milk foam. The milk foam finally sprays out from the milk outlet pipe 7. When the milk frothing assembly needs to be disassembled and cleaned, the case body 4 is removed, and the mixing chamber can be easily cleaned. In this embodiment, the lid 2 is detachably connected to the container 1, and the milk inlet pipe 5 and the milk outlet pipe 7 are detachably connected to the lid 2. Therefore, the container 1, the lid 2, the milk inlet pipe 5, and the milk outlet pipe 7 can all be removed for cleaning.

The upper side of the lid 2 protrudes upwardly to form a rib structure 24, and the rib structure 24 surrounds a space to form the mixing groove. The lower side of the case body 4 comprises a sealing cushion structure 45, and the sealing cushion structure 45 presses the rib structure 24 to form the mixing chamber. In this embodiment, the sealing cushion structure 45 is made of silicone material, and the rib structure 24 and the sealing cushion structure 45 abut each other to prevent the mixing chamber from leakage.

In this embodiment, an air inlet valve 8 is provided, and the air inlet valve 8 forms the air inlet port 41. The air inlet valve 8 is detachably disposed on the case body 4. The air inlet port 41 corresponds to the milk inlet pipe 5.

The upper side of the lid 2 comprises one or more first hooks 22 and one or more second hooks 23. A first side of the case body 4 is buckled to the one or more first hooks 22, and a second side of the case body 4 is buckled to the one or more second hooks 23. The one or more second hooks 23 are elastic. When the first side of the case body 4 is buckled to the one or more first hooks 22, the second side of the case body 4 can be rotated around the one or more first hooks 22 as a center of rotation to be buckled to the one or more second hooks 23. In this embodiment, the first side of the case body 4 comprises two buckles 42 spaced apart from each other, and the one or more first hooks 22 on the upper side of the lid 2 are two first hooks 22 spaced apart from each other. Each of the two first hooks 22 comprises an upright wall 221 and a bent arm 222 connected to an upper end of the upright wall 221, and the two buckles 42 can be rotatably buckled on the bent arms 222 of the two first hooks 22. The second side of the case body 4 comprises a protruding portion 43. The one or more second hooks 23 on the upper side of the lid 2 are a single elastic hook, which is buckled to the protruding portion 43, and the single elastic hook can be released from a buckling connection with the protruding portion 43 by an external force.

The steam port 6 is connected to the case body 4, and the lower side of the case body 4 forms a steam outlet port 44 connecting the steam port 6 and the mixing chamber. The mixing groove comprises a steam section 211, a mixing section 212, and a steam outlet section 213. The mixing section 212 is connected to the steam section 211 and the steam outlet section 213. A width of the mixing section 212 is smaller than a width of the steam section 211 and a width of the steam outlet section 213. The milk inlet pipe 5 is connected to the mixing section 212, and the milk outlet pipe 7 is connected to the steam outlet section 213. When the lower side of the case body 4 closes the mixing groove, the steam outlet port 44 is connected to the steam section 211, and the air inlet port 41 corresponds to the mixing section 212. The steam outlet section 213 is circular, and the steam outlet section 213 comprises an outlet 2131. The outlet 2131 is connected to the milk outlet pipe 7. The outlet 2131 and the mixing section 212 are respectively tangentially connected to the steam outlet section 213.

In this embodiment, the milk outlet pipe 7 is rotatably connected to the lid 2.

When in use, the steam port 6 is connected to the steam, the steam enters the steam section 211 through the steam outlet port 44, and then the steam enters the steam outlet section 213 through the mixing section 212. Since the width of the mixing section 212 is smaller than the width of the steam section 211 and the width of the steam outlet section, a flow rate of the steam passing through the mixing section 212 is increased, forming a Venturi effect to respectively suck the milk and the air from the container 1 and an external atmosphere, and the milk, the air, and the steam are mixed with each other in the steam outlet section 213 to form the milk foam, and finally sprayed out from the milk outlet pipe 7.

When cleaning is needed, the single elastic hook only needs to be pressed to disassemble the case body 4, and the case body 4 and the mixing groove can be cleaned separately.

The above description is only a preferred specific implementation of the present disclosure, but the design concept of the present disclosure is not limited thereto. Any technician familiar with the technical field, within the technical scope disclosed by the present disclosure, that uses this concept to make non-substantial changes to the present disclosure, is considered to engage in an act of infringing the protection scope of the present disclosure.

What is claimed is:

1. A milk frothing assembly, comprising:
a container,
a lid, and
a case body, wherein:
the container is configured to contain liquid,
the lid covers the container,
the milk frothing assembly comprises a milk inlet pipe, a steam port, and a milk outlet pipe,
the milk inlet pipe is inserted into the container,
an upper side of the lid forms a mixing groove,
the mixing groove is respectively connected to the milk inlet pipe, the milk outlet pipe, and the steam port,
the case body is detachably connected to the upper side of the lid,
a lower side of the case body is configured to seal the mixing groove to form a mixing chamber,
an air inlet port is connected to the mixing chamber, and
the steam port is configured to receive steam.

2. The milk frothing assembly according to claim 1, wherein:
the upper side of the lid comprises one or more first hooks and one or more second hooks,
a first side of the case body is buckled to the one or more first hooks, and
a second side of the case body is buckled to the one or more second hooks.

3. The milk frothing assembly according to claim 2, wherein:
the one or more second hooks are elastic hooks, and
when the first side of the case body is buckled to the one or more first hooks, the second side of the case body is configured to be rotated around the one or more first hooks as a center of rotation to be buckled to the one or more second hooks.

4. The milk frothing assembly according to claim 3, wherein:
the first side of the case body comprises two buckles spaced apart from each other,
the one or more first hooks on the upper side of the lid are two first hooks spaced apart from each other,
each of the two first hooks comprises an upright wall and a bent arm connected to an upper end of the upright wall,
the two buckles are configured to be rotatably buckled on the bent arms of the two first hooks,
the second side of the case body comprises a protruding portion,
the one or more second hooks on the upper side of the lid are a single elastic hook, which is buckled to the protruding portion, and
the single elastic hook is configured to be released from a buckling connection with the protruding portion by an external force.

5. The milk frothing assembly according to claim 1, wherein:
the steam port is connected to the case body, and
the lower side of the case body forms a steam outlet port connecting the steam port and the mixing chamber.

6. The milk frothing assembly according to claim 5, wherein:
the mixing groove comprises a steam section, a mixing section, and a steam outlet section,
the mixing section is connected to the steam section and the steam outlet section,
a width of the mixing section is smaller than a width of the steam section and a width of the steam outlet section,
the milk inlet pipe is connected to the mixing section,
the milk outlet pipe is connected to the steam outlet section, and
when the lower side of the case body seals the mixing groove, the steam outlet port is connected to the steam section, and the air inlet port corresponds to the mixing section.

7. The milk frothing assembly according to claim 6, wherein:
the steam outlet section is circular,
the steam outlet section comprises an outlet,
the outlet is connected to the milk outlet pipe, and
the outlet and the mixing section are respectively tangentially connected to the steam outlet section.

8. The milk frothing assembly according to claim 1, wherein:
the lid is detachably connected to the container,
the milk outlet pipe is rotatably connected to the lid, and
the milk inlet pipe and the milk outlet pipe are detachably connected to the lid.

9. The milk frothing assembly according to claim 1, wherein:
the upper side of the lid protrudes upwardly to form a rib structure,
the rib structure surrounds a space to form the mixing groove,
the lower side of the case body comprises a sealing cushion structure, and
the sealing cushion structure presses the rib structure to form the mixing chamber.

10. The milk frothing assembly according to claim 1, comprising:
an air inlet valve, wherein:
the case body comprises an air inlet port,
the air inlet valve forms the air inlet port, and
the air inlet valve is detachably disposed on the case body.
